(19) United States
(12) Patent Application Publication
(10) Pub. No.: US 2025/0226797 A1
(43) Pub. Date: Jul. 10, 2025

(54) PHOTOVOLTAIC DEVICE SEARCH METHOD, MANAGEMENT MODULE, SYSTEM, AND STORAGE MEDIUM

(71) Applicant: HOYMILES POWER ELECTRONICS INC., Hangzhou (CN)

(72) Inventors: Hongbin YU, Hangzhou (CN); Shigao ZHOU, Hangzhou (CN); Yanwei WU, Hangzhou (CN); Qiang RONG, Hangzhou (CN); Yi ZHAO, Hangzhou (CN); Bo YANG, Hangzhou (CN)

(73) Assignee: HOYMILES POWER ELECTRONICS INC., Hangzhou (CN)

(21) Appl. No.: 19/089,072

(22) Filed: Mar. 25, 2025

Related U.S. Application Data
(63) Continuation of application No. PCT/CN2023/139442, filed on Dec. 18, 2023.

(30) Foreign Application Priority Data
Oct. 19, 2022 (CN) 202211279814.4

(51) Int. Cl. H02S 50/10; H02J 3/38; H02S 40/32

(52) U.S. Cl. CPC H02S 50/10; H02J 3/381; H02S 40/32; H02J 2300/24

(57) ABSTRACT

A photovoltaic device search method, a management module, a photovoltaic system, and a storage medium are provided. The method includes: sending a search instruction for a first photovoltaic device to photovoltaic devices; determining a first photovoltaic device and achieving search for the first photovoltaic device in each photovoltaic string based on a first response signal sent by a photovoltaic device that successfully responds to the search instruction for the first photovoltaic device, the first photovoltaic device being configured to determine a second photovoltaic device that is located in the same photovoltaic string as the first photovoltaic device; and sending a search instruction for a second photovoltaic device to the photovoltaic devices based on the first photovoltaic device, so as to implement search for the second photovoltaic device in each photovoltaic string.

### CROSS-REFERENCE TO RELATED APPLICATIONS

This application is a continuation of international patent application No. PCT/CN2023/139442, filed on Dec. 18, 2023, which itself claims priority to Chinese patent application No. 202211279814.4, filed on Oct. 19, 2022, titled “PHOTOVOLTAIC DEVICE SEARCH METHOD, MANAGEMENT MODULE, SYSTEM, AND STORAGE MEDIUM”. The contents of the above identified applications are hereby incorporated herein in their entireties by reference.

### TECHNICAL FIELD

The present disclosure generally relates to the field of photovoltaic power generation technology, and in particular, to a photovoltaic device search method, a management module, a photovoltaic system, and a storage medium.

### BACKGROUND

With development of photovoltaic power generation technology, MLPE (module level power electronics) photovoltaic devices are widely applied in photovoltaic systems. The MLPE photovoltaic device can be configured to perform a maximum power point tracing, a rapid shutdown operation, a data collection and monitoring, or the like on a photovoltaic module.

Generally, one or more photovoltaic modules are configured with one MLPE photovoltaic device. Therefore, there is a relatively large quantity of MLPE photovoltaic devices in the photovoltaic system. To accurately obtain information of each photovoltaic module and facilitate later maintenance, or the like, it is necessary to clearly know location information of each photovoltaic device, including information about which photovoltaic string each MLPE photovoltaic device belongs to.

In the related art, to determine the location information of each photovoltaic device, it is usually necessary to search for the photovoltaic device first. When searching for the photovoltaic device, searching is performed for certain times within a range of all photovoltaic devices, and all the photovoltaic devices competitively respond each time until device information of all the photovoltaic devices is acquired. Apparently, a search range of a search method in the related art is too large, which results in low search efficiency.

### SUMMARY

According to various embodiments of the present disclosure, a photovoltaic device grouping method, a management module, a photovoltaic device, a system, and a storage medium are provided.

In a first aspect, a photovoltaic device search method is provided and applied to a management module in a photovoltaic system. The photovoltaic system further includes at least one photovoltaic string, each of which includes a plurality of photovoltaic devices connected in series and a plurality of photovoltaic modules connected to the plurality of photovoltaic devices respectively, and the method includes: sending a search instruction for a first photovoltaic device to the plurality of photovoltaic devices, determining a first photovoltaic device and achieving search for the first photovoltaic device in each of the at least one photovoltaic string based on a first response signal sent by a photovoltaic device that successfully responds to the search instruction for the first photovoltaic device, the first photovoltaic device being configured to determine a second photovoltaic device that is located in a same photovoltaic string as the first photovoltaic device, and sending a search instruction for a second photovoltaic device to the plurality of photovoltaic devices based on the first photovoltaic device, so as to implement search for the second photovoltaic device in each of the at least one photovoltaic string. The second photovoltaic device located in the same photovoltaic string as the first photovoltaic device competitively participates in responding to the search instruction for the second photovoltaic device.

In an embodiment, the first response signal includes identification of the photovoltaic device that successfully responds to the search instruction for the first photovoltaic device.

In an embodiment, the search instruction for the second photovoltaic device includes identification of the first photovoltaic device. The second photovoltaic device located in the same photovoltaic string as the first photovoltaic device competitively participates in responding to the search instruction for the second photovoltaic device.

In an embodiment, before sending the search instruction for the second photovoltaic device, the method further includes: broadcasting a notification instruction to the plurality of photovoltaic devices. The notification instruction includes identification of the first photovoltaic device, and the notification instruction is configured to notify the second photovoltaic device located in the same photovoltaic string as the first photovoltaic device to competitively participate in responding to the search instruction for the second photovoltaic device.

In an embodiment, photovoltaic devices other than the first photovoltaic device and the second photovoltaic device competitively participate in responding to the search instruction for the first photovoltaic device.

In an embodiment, after sending the search instruction for the first photovoltaic device to the plurality of photovoltaic devices, the method further includes: sending a second signal instruction to the plurality of photovoltaic devices. The second signal instruction includes a signal threshold configured to determine a second photovoltaic device that is located in the same photovoltaic string as a corresponding first photovoltaic device and grouping information of the second photovoltaic device, the grouping information is determined by the second photovoltaic device according to a signal feature of a response signal received by the second photovoltaic device and a corresponding signal threshold, and the grouping information includes identification of the corresponding first photovoltaic device.

In an embodiment, the second signal instruction is configured to instruct each of the plurality of photovoltaic devices to determine wherein a corresponding photovoltaic device is the second photovoltaic device based on a signal feature of a received first response signal and a corresponding signal threshold.

In an embodiment, the second signal instruction further includes identification of the corresponding first photovoltaic device configured to register the corresponding first photovoltaic device.

In an embodiment, the method further include: receiving a third response signal sent by a second photovoltaic device that successfully responds to the search instruction for the second photovoltaic device. The third response signal includes identification of the second photovoltaic device.

In an embodiment, after receiving the third response signal sent by the second photovoltaic device that successfully responds to the search instruction for the second photovoltaic device, the method further includes: sending a registering instruction for a second photovoltaic device to the second photovoltaic device. The registering instruction for the second photovoltaic device includes the identification of the second photovoltaic device in the third response signal, and the registering instruction for the second photovoltaic device is configured to register a corresponding second photovoltaic device.

In an embodiment, both the second signal instruction and the registering instruction for the second photovoltaic device further include a logical address assigned to a corresponding photovoltaic device to implement networking of photovoltaic devices.

In a second aspect, a management module is provided and applied to a photovoltaic system. The photovoltaic system further includes at least one photovoltaic string, each of which includes a plurality of photovoltaic devices connected in series and a plurality of photovoltaic modules connected to the plurality of photovoltaic devices respectively, and the management module includes a first search module and a second search module.

The first search module is configured for sending a search instruction for a first photovoltaic device to the plurality of photovoltaic devices, and determining a first photovoltaic device and achieving search for the first photovoltaic device in each of the at least one photovoltaic string based on a first response signal sent by a photovoltaic device that successfully responds to the search instruction for the first photovoltaic device. The first photovoltaic device is configured to determine a second photovoltaic device that is located in a same photovoltaic string as the first photovoltaic device.

The second search module is configured for sending a search instruction for a second photovoltaic device to the plurality of photovoltaic devices based on the first photovoltaic device, so as to implement search for the second photovoltaic device in each of the at least one photovoltaic string. The second photovoltaic device located in the same photovoltaic string as the first photovoltaic device competitively participates in responding to the search instruction for the second photovoltaic device.

In a third aspect, a photovoltaic system is provided, including the at least one photovoltaic string and the management module in the second aspect. Each of the at least one photovoltaic string includes a plurality of photovoltaic devices connected in series and a plurality of photovoltaic modules connected to the plurality of photovoltaic devices respectively.

In a fourth aspect, a computer-readable storage medium is provided, storing a computer program. The computer program is executed by a processor to perform the method in the first aspect.

Details of one or more embodiments of the present disclosure are proposed in the following accompanying drawings and descriptions, so that other features, objects, and advantages of the present disclosure are more easily understood.

### BRIEF DESCRIPTION OF THE DRAWINGS

In order to more clearly describe technical solutions in the embodiments or the related art, the following briefly describes the accompanying drawings required for describing the embodiments or the related art. Apparently, the accompanying drawings in the following description show merely the embodiments of the present disclosure, and one skilled in the art may still derive other drawings from the disclosed accompanying drawings without creative efforts.

FIG. 1 is a schematic diagram of a photovoltaic system in an embodiment.

FIG. 2 is a schematic diagram of a photovoltaic system in another embodiment.

FIG. 3 is a flowchart of a photovoltaic device search method in an embodiment.

FIG. 4 is an overall flowchart of a determining method of a first photovoltaic device and a second photovoltaic device in an embodiment.

FIG. 5 is an overall flowchart of a photovoltaic device grouping method in an embodiment.

FIG. 6 is a schematic diagram of a management module in an embodiment.

FIG. 7 is a schematic diagram of a computer device in an embodiment.

### DETAILED DESCRIPTION OF THE EMBODIMENT

The following clearly and completely describes the technical solutions in the embodiments of the present disclosure with reference to the accompanying drawings in the embodiments of the present disclosure. Apparently, the described embodiments are merely some rather than all of the embodiments of the present disclosure. Based on the embodiments of the present disclosure, all other embodiments obtained by one skilled in the art without creative efforts fall within the protection scope of the present disclosure.

As shown in the present disclosure, unless the context clearly indicates an exception, words such as “one”, “a”, “a kind of”, and/or “the” do not specifically refer to singular, but may also include plural. Generally speaking, terms “include” and “contain” only indicate steps and elements that have been clearly identified are included, and these steps and elements do not constitute an exclusive list. Methods or devices may also contain other steps or elements.

Although various references are made to certain modules in a system according to embodiments of the present disclosure, any number of different modules may be used and run on computing devices and/or processors. The modules are only illustrative, and different aspects of the system and method may use different modules.

When a unit or a module is described as “connecting” or “coupling” with other units, modules, or blocks, it may refer to direct connection or coupling, or communication with other units, modules, or blocks, or there may be intermediate units, modules, or blocks, unless otherwise specified in the context. The term “and/or” used in this article may include any and all combinations of one or more related listed items.

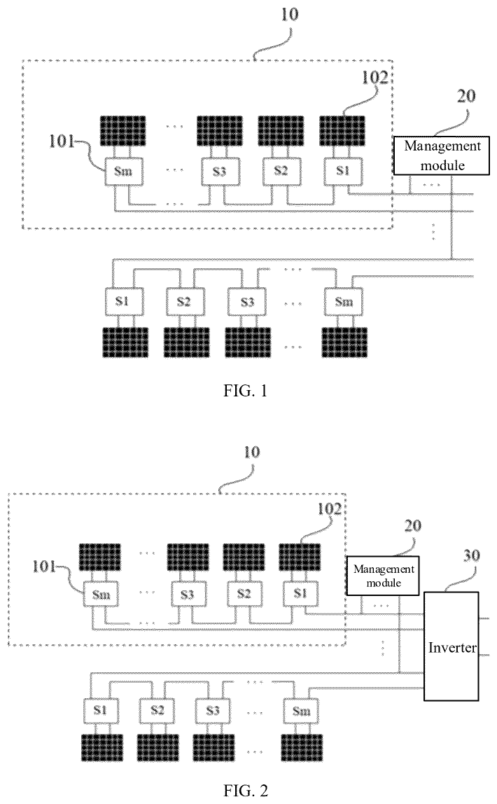

FIG. 1 is a schematic diagram of a photovoltaic system in an embodiment of the present disclosure. The photovoltaic system includes at least one photovoltaic string 10 and a management module 20. Each of the at least one plurality of photovoltaic strings 10 includes a plurality of photovoltaic devices 101 (i.e., S1 to Sm in FIG. 1) connected in series and a plurality of photovoltaic modules 102 connected to the plurality of photovoltaic devices 101, respectively. The plurality of photovoltaic modules 102 are configured to provide direct current. The management module 20 is configured to communicate with each of the plurality of photovoltaic devices 101 and search and group the plurality of photovoltaic devices 101.

The plurality of photovoltaic devices 101 may include shutdown devices, optimizers, micro-inverters, monitors, and so on. For example, the management module 20 may be coupled to the at least one photovoltaic string 10 by a current transformer, and the management module 20 includes a controller or a processor, such as, a MCU (Micro Controller Unit), which is not limited thereto. The management module 20 may communicate with each of the plurality of photovoltaic devices 101, for example, by power line carrier.

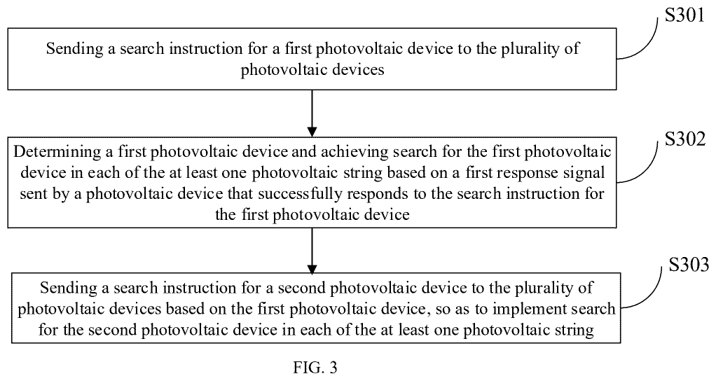

FIG. 2 is a schematic diagram of the photovoltaic system in another embodiment of the present disclosure. The photovoltaic system includes an inverter 30, at least one photovoltaic string 10 connected to the inverter 30, and a management module 20. Each of the at least one photovoltaic string 10 includes a plurality of photovoltaic devices 101 (i.e., S1 to Sm in FIG. 1) connected in series and a plurality of photovoltaic modules 102 connected to the plurality of photovoltaic devices 101, respectively. The inverter 30 is configured to convert direct current provided by the plurality of photovoltaic modules 102 into alternating current and output the alternating current. The management module 20 may communicate with each of the plurality of photovoltaic devices 101.

The plurality of the photovoltaic devices 101 may include the shutdown devices, the optimizers, the monitors, and so on. The plurality of photovoltaic devices 101 which are located at a same photovoltaic string are connected in series. The at least one photovoltaic string 10 is connected to a plurality of direct-current input ports of the inverter 30, respectively. For example, the management module 20 may be coupled to the at least one photovoltaic string 10 by a current transformer, which is not limited thereto. The management module 20 may communicate with each of the plurality of photovoltaic devices 101, for example, by the power line carrier.

The management module 20 is configured for communicating with the plurality of photovoltaic devices 101, searching the plurality of photovoltaic devices 101, and acquiring identification of the plurality of photovoltaic devices 101.

In an embodiment, the management module 20 may be integrated in the inverter 30.

In an embodiment, referring to FIG. 3, a photovoltaic device search method is provided, this method applied to the management module in the photovoltaic system in FIG. 1 or FIG. 2 is taken as an example for explanation, including following step 301 to step 303.

Step 301 includes sending a search instruction for a first photovoltaic device to the plurality of photovoltaic devices.

The plurality of photovoltaic devices may respond to the search instruction for the first photovoltaic device in a competitive-response manner, and a photovoltaic device that successfully responds to the search instruction for the first photovoltaic device may send a first response signal.

Step 302 includes determining a first photovoltaic device and achieving search for the first photovoltaic device in each of the at least one photovoltaic string based on a first response signal sent by a photovoltaic device that successfully responds to the search instruction for the first photovoltaic device.

The first photovoltaic device is configured to determine a second photovoltaic device that is located in a same photovoltaic string as the first photovoltaic device. The first photovoltaic device may be any photovoltaic device in each of the at least one photovoltaic string, such as a photovoltaic device in a photovoltaic string that communicates with the management module first. The second photovoltaic device may be a photovoltaic device except the first photovoltaic device.

The first response signal may be sent in a broadcast manner.

When the first response signal received by the management module is normal, it may indicate that one photovoltaic device successfully responds.

When the received first response signal is abnormal, the search instruction for the first photovoltaic device may be repeatedly sent until a normal first response signal is received. The situation where the first response signal is abnormal may include any one of the following: the first response signal uploaded by the photovoltaic device and received by the management module is abnormal due to garbled codes or signal interference, etc.

Step 303 includes sending a search instruction for a second photovoltaic device to the plurality of photovoltaic devices based on the first photovoltaic device, so as to implement search for the second photovoltaic device in each of the at least one photovoltaic string.

The second photovoltaic device located in the same photovoltaic string as the first photovoltaic device competitively participates in responding to the search instruction for the second photovoltaic device.

The management module may send the search instruction for the second photovoltaic device in a broadcast manner.

Based on the above step 301 to step 303, the search instruction for the first photovoltaic device may be sent to the plurality of photovoltaic devices, the first photovoltaic device in each of the at least one photovoltaic string is determined and searched based on the first response signal sent by the photovoltaic device that successfully responds to the search instruction for the first photovoltaic device, and the first photovoltaic device is configured to determine the second photovoltaic device that is located in the same photovoltaic string as the first photovoltaic device. The search instruction for the second photovoltaic device is sent to the plurality of photovoltaic devices based on the first photovoltaic device, so as to implement search for the second photovoltaic device in each of the at least one photovoltaic string. The second photovoltaic device located in the same photovoltaic string as the first photovoltaic device competitively participates in responding to the search instruction for the second photovoltaic device. In the present disclosure, each search only applies to the second photovoltaic device located in the same photovoltaic string as the first photovoltaic device, and a search range may be narrowed from the entire photovoltaic system to a single photovoltaic string, thereby improving search efficiency.

In an embodiment, the first response signal may include identification of the photovoltaic device that successfully responds to the search instruction for the first photovoltaic device. The photovoltaic device may be determined as the first photovoltaic device according to the first response signal.

In an embodiment, the identification of the photovoltaic device may be a sequence number of the photovoltaic device.

The photovoltaic device may respond to the search instruction for the first photovoltaic device in a competitive-response manner. The photovoltaic device that successfully responds to the search instruction for the first photovoltaic device may send the first response signal.

In an embodiment, the search instruction for the second photovoltaic device may include identification of the first photovoltaic device. The second photovoltaic device located in the same photovoltaic string as the first photovoltaic device may competitively participate in responding to the search instruction for the second photovoltaic device.

The search instruction for the second photovoltaic device may include the identification of the first photovoltaic device, and the second photovoltaic device located in the same photovoltaic string as the first photovoltaic device may competitively participate in responding to the search instruction for the second photovoltaic device, so that the search range for the second photovoltaic device may be narrowed to one photovoltaic string. The search range may be greatly narrowed, and search efficiency for the second photovoltaic device may be improved.

Furthermore, an unregistered second photovoltaic device that is located in the same photovoltaic string as the first photovoltaic device may competitively participate in responding to the search instruction for the second photovoltaic device, thereby further narrowing the search range and improving search efficiency.

In another embodiment, before sending the search instruction for the second photovoltaic device, the method may further include: broadcasting a notification instruction to the plurality of photovoltaic devices. The notification instruction may include identification of a first photovoltaic device, and the notification instruction is configured to notify the second photovoltaic device located in the same photovoltaic string as the first photovoltaic device to competitively participate in responding to the search instruction for the second photovoltaic device.

Before the management module sends the search instruction for the second photovoltaic device, the management module may send a notification instruction in the broadcast manner. The notification instruction may include identification of a first photovoltaic device, and the notification instruction is configured to notify second photovoltaic devices that the second photovoltaic device located in the same photovoltaic string as the first photovoltaic device specified in the notification instruction responds to the search instruction for the second photovoltaic device that is sent later, so that the search instruction for the second photovoltaic device does not need to carry the identification of the first photovoltaic device. Similarly, the search range for the second photovoltaic device may be narrowed to one photovoltaic string. The search range may be greatly narrowed, and search efficiency for the second photovoltaic device may be improved.

In an embodiment, when the management module does not receive a third response signal, the management module would repeatedly send the search instruction for the second photovoltaic device. When the management module does not receive the third response signal for certain times, the management module would stop sending the search instruction for the second photovoltaic device, and the search for the second photovoltaic device may end.

In an embodiment, before sending the search instruction for the first photovoltaic device to the plurality of photovoltaic devices, the method may further include: sending a competitive-response instruction to the plurality of photovoltaic devices. The photovoltaic device that successfully responds to the competitive-response instruction may competitively participate in responding to the search instruction for the first photovoltaic device.

In the present embodiment, the photovoltaic device that successfully responds to the competitive-response instruction may competitively participate in responding to the search instruction for the first photovoltaic device. For example, each of the at least one photovoltaic string may only have one photovoltaic device successfully responds to the competitive-response instruction, so as to narrow the search range for the first photovoltaic device greatly and improve search efficiency for devices.

In another embodiment, photovoltaic devices other than the first photovoltaic device and the second photovoltaic device may competitively participate in responding to the search instruction for the first photovoltaic device, which may further narrow the search range for the first photovoltaic device and improve search efficiency for devices.

Furthermore, when the management module determines there is no response for the competitive-response instruction, the management module may repeatedly send the competitive-response instruction for certain times, and if there is still no response for the competitive-response instruction, the management module may send a search instruction for the second photovoltaic device.

In an embodiment, after sending the search instruction for the first photovoltaic device to the plurality of photovoltaic devices, the method may further include: sending a second signal instruction to the plurality of photovoltaic devices.

The second signal instruction may include a signal threshold configured to determine the second photovoltaic device that is located in the same photovoltaic string as a corresponding first photovoltaic device and grouping information of the second photovoltaic device, the grouping information may be determined by the second photovoltaic device according to a signal feature of a received response signal and a corresponding signal threshold, and the grouping information may include identification of the corresponding first photovoltaic device.

A value of the signal threshold may be set by the management module according to a signal margin and a value of the signal feature of the response signal sent by the photovoltaic device and received by the management module. The value of the signal threshold in the second signal instruction sent each time may be different.

Furthermore, the signal margin may be set according to a practical situation, and the signal threshold may be a difference between the signal margin and the value of the signal feature of the response signal that is sent by the first photovoltaic device and received by the management module.

In an embodiment, the grouping information may be determined by the second photovoltaic device according to a signal feature of the first response signal received by the second photovoltaic device and a corresponding signal threshold.

The signal feature may include at least one of signal amplitude, signal impedance, or signal attenuation.

The plurality of photovoltaic devices may be connected by a power line. Due to the cable impedance, the value of the signal feature of the response signal sent by a first photovoltaic device and received by the second photovoltaic device located in the same photovoltaic string as the first photovoltaic device may be different from that of the signal feature of the response signal sent by the first photovoltaic device and received by a second photovoltaic device located in a different photovoltaic string as the first photovoltaic device. The value of the signal feature of the response signal sent by the first photovoltaic device and received by the second photovoltaic device located in the same photovoltaic string as the first photovoltaic device may be greater or less than that of the signal feature of the response signal sent by the first photovoltaic device and received by the second photovoltaic device located in the different photovoltaic string as the first photovoltaic device (it is considered that the signal feature may be the signal amplitude, the signal attenuation, or the signal impedance). The difference between the two values may be relatively great, so that grouping information may be generated according to the signal feature of the response signal.

In an embodiment, the second signal instruction may further include identification of the first photovoltaic device, configured to register the corresponding first photovoltaic device, so as to notify the photovoltaic device corresponding to the identification that itself has been registered as the first photovoltaic device.

The second signal instruction may be sent in a broadcast manner.

In an embodiment, while the management module sends the second signal instruction, the management module may notify photovoltaic devices other than the first photovoltaic device to generate the grouping information based on the second signal instruction, respectively. The grouping information may be identification of the first photovoltaic device that is in the same photovoltaic string as the second photovoltaic device, and the grouping information may be stored in the second photovoltaic device.

The other photovoltaic devices may determine whether themselves are located in the same photovoltaic string as the corresponding first photovoltaic device according to the signal feature of the received first response signal and the corresponding signal threshold, and update a corresponding status identifier and identification (i.e., the grouping information) of the first photovoltaic device. The status identifier is configured to indicate that the corresponding photovoltaic device is one of the first photovoltaic device, the second photovoltaic device, or a to-be-grouped photovoltaic device.

In an embodiment, the second signal instruction is configured to instruct each of the plurality of photovoltaic devices to determine wherein itself is the second photovoltaic device based on the signal feature of the received first response signal and a corresponding signal threshold.

In an embodiment, after receiving the second signal instruction, the other photovoltaic devices may first determine whether the identification of the photovoltaic device carried in the received first response signal is consistent with that of the photovoltaic device carried in the second signal instruction. If yes, the value of the signal feature of the received first response signal may be compared with the corresponding signal threshold; if no, it may be considered that the first response signal is not sent by the first photovoltaic device specified by the second signal instruction, and no comparison may be made. For example, it is determined whether a sequence number of the photovoltaic device carried in the received first response signal is the same as that of the photovoltaic device carried in the second signal instruction.

In an embodiment, the signal feature may be the signal amplitude, and the photovoltaic device may compare the signal amplitude of the received first response signal with a corresponding signal threshold. When the signal amplitude of the received first response signal is greater than the corresponding signal threshold, it may be considered that the photovoltaic device and the corresponding first photovoltaic device belong to the same photovoltaic string, and the photovoltaic device may be determined as the second photovoltaic device.

In another embodiment, the second photovoltaic device may receive first response signals sent by a plurality of different first photovoltaic devices. When the second photovoltaic device determines that the signal amplitudes of the received first response signals are greater than the corresponding signal thresholds respectively, the second photovoltaic device may sort differences between the signal amplitudes of the received first response signals sent by the plurality of first photovoltaic devices and the corresponding signal thresholds, determine a first photovoltaic device with a maximum difference to be in the same photovoltaic group string as itself, and update the stored identification of the first photovoltaic device to the identification of the first photovoltaic device with the maximum difference.

In another embodiment, the second photovoltaic device may receive first response signals sent by a plurality of different first photovoltaic devices. When the second photovoltaic device determines that the signal amplitudes of the received first response signals are greater than the corresponding signal thresholds respectively, the second photovoltaic device may sort the signal amplitudes of the received first response signals sent by the plurality of first photovoltaic devices, determine a first photovoltaic device with a maximum signal amplitude to be in the same photovoltaic group string as itself, and update the stored identification of the first photovoltaic device to the identification of the first photovoltaic device with the maximum signal amplitude.

It should be noted that, when the signal feature is the signal impedance or the signal attenuation, the principle of a determining method of the grouping information may be basically the same as that of the determining method of the grouping information in any one of the foregoing embodiments, and details are not described again.

In an embodiment, the method may further include: receiving a second response signal sent by a photovoltaic device responding to the second signal instruction. If the management module receives the second response signal, it may indicate that a photovoltaic device is successfully registered as the first photovoltaic device.

In an embodiment, it is considered that some photovoltaic devices may not receive the first response signal, when the first photovoltaic device sends the second response signal, the management module and other photovoltaic devices may record the identification of the photovoltaic device in the second response signal and the signal feature of the second response signal, and the management module may send the second signal instruction again or repeatedly send the second signal instruction for certain times. In this situation, other photovoltaic devices may determine, according to the signal feature of the received second response signal and a corresponding signal threshold, whether the photovoltaic device and the corresponding first photovoltaic device belong to the same photovoltaic group string, which prevents devices from being not searched or registered.

It should be noted that, a method of determining, according to the signal feature of the received second response signal and the corresponding signal threshold, whether the photovoltaic device and the corresponding first photovoltaic device belong to the same photovoltaic group string may be the same as a method of determining, according to the signal feature of the first response signal and the corresponding signal threshold, whether the photovoltaic device and the corresponding first photovoltaic device belong to the same photovoltaic group string. Therefore, details are not described again.

In an embodiment, the method may further include: receiving a third response signal sent by the second photovoltaic device that successfully responds to the search instruction for the second photovoltaic device.

The third response signal may include identification of the second photovoltaic device.

In an embodiment, the identification of the photovoltaic device may include a sequence number of the photovoltaic device.

When the management module does not receive the third response signal, the management module may send the search instruction for the second photovoltaic device again or repeatedly send the search instruction for the second photovoltaic device for certain times.

In an embodiment, after receiving the third response signal sent by the second photovoltaic device that successfully responds to the search instruction for the second photovoltaic device, the method may further include: sending a registering instruction for a second photovoltaic device to the second photovoltaic device, and receiving a fourth response signal sent by the second photovoltaic device responding to the registering instruction for the second photovoltaic device.

In an embodiment, the registering instruction for the second photovoltaic device may include the identification of the second photovoltaic device, the registering instruction for the second photovoltaic device is configured to register the corresponding second photovoltaic device, and the second photovoltaic device corresponding to the identification may be notified that itself has been registered. Subsequently, the registered second photovoltaic device does not respond to the search instruction for the second photovoltaic device any more, thereby further narrowing the search range for the second photovoltaic device and improving search efficiency.

In an embodiment, the step of receiving the fourth response signal sent by the second photovoltaic device responding to the registering instruction for the second photovoltaic device may be omitted. In this situation, the registering instruction for the second photovoltaic device may be repeatedly sent to the second photovoltaic device for certain times.

In an embodiment, both the second signal instruction and the registering instruction for the second photovoltaic device may further include a logical address assigned to a corresponding photovoltaic device to implement networking of photovoltaic devices.

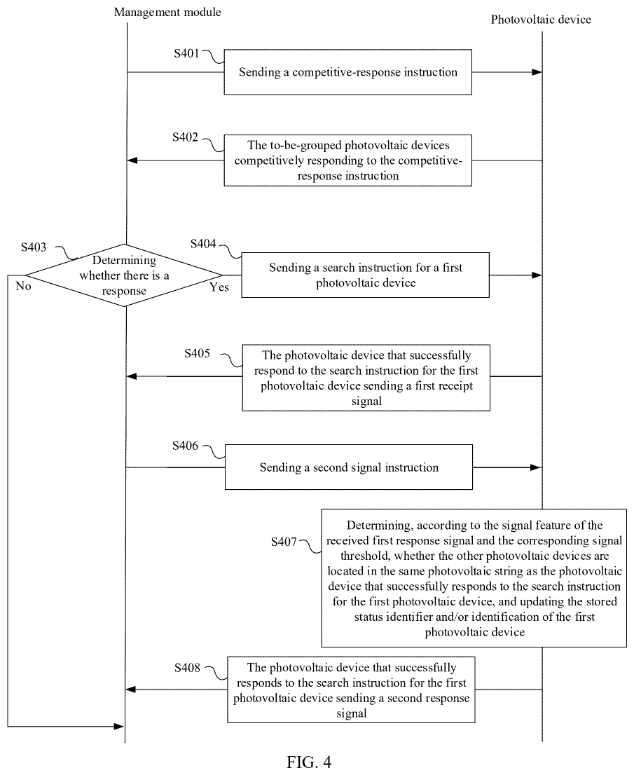

In a specific embodiment, an overall flowchart of a photovoltaic device search method may refer to FIG. 4, including the following step 401 to step 414.

Step 401 may include that the management module sending a competitive-response instruction.

Step 402 may include that the to-be-grouped photovoltaic devices competitively responding to the competitive-response instruction.

The to-be-grouped photovoltaic devices may include photovoltaic devices other than the first photovoltaic device and the second photovoltaic device. After receiving the competitive-response instruction and completing a random delay, the to-be-grouped photovoltaic devices may detect whether a channel is idle. If yes, the to-be-grouped photovoltaic devices may reply to the competitive-response instruction and successfully respond; if no, the to-be-grouped photovoltaic devices may not reply to the competitive-response instruction and may fail to respond.

Step 403 may include that the management module determining whether there is a response, if yes, performing step 404; if no, performing step 409.

Step 404 may include that the management module sending a search instruction for a first photovoltaic device.

At the present step, the photovoltaic device that successfully responds to the competitive-response instruction may competitively respond to the search instruction for the first photovoltaic device.

After step 401 to step 403, for example, each of the at least one photovoltaic string may only have one photovoltaic device successfully responds to the competitive-response instruction, so when the step 404 is performed, the search range for the first photovoltaic device may be greatly narrowed, improving the efficiency of search for devices.

Step 405 may include that the photovoltaic device that successfully responds to the search instruction for the first photovoltaic device sending a first response signal.

When one photovoltaic device successfully responds to the search instruction for the first photovoltaic device and returns the first response signal, the management module and other photovoltaic devices may record the identification carried in the first response signal and the signal feature of the first response signal.

The management module may determine the photovoltaic device that successfully replies the first response signal as the first photovoltaic device of a photovoltaic string where the photovoltaic device is located.

The photovoltaic device that successfully respond each time may be located in different photovoltaic strings.

Step 406 may include that the management module sending a second signal instruction.

The second signal instruction may include a signal threshold configured to determine the second photovoltaic device that is located in the same photovoltaic string as the corresponding first photovoltaic device and grouping information of the second photovoltaic device.

The second signal instruction may further include the identification of the first photovoltaic device configured to register the photovoltaic device that successfully responds to the search instruction for the first photovoltaic device, so as to notify the photovoltaic device corresponding to the identification that itself has been registered as the first photovoltaic device.

Step 407 may include that after receiving the second signal instruction, the other photovoltaic devices determining, according to the signal feature of the received first response signal and the corresponding signal threshold, whether the other photovoltaic devices are located in the same photovoltaic string as the photovoltaic device that successfully responds to the search instruction for the first photovoltaic device, and updating the stored status identifier and/or identification of the first photovoltaic device.

After receiving the second signal instruction, the other photovoltaic devices may first determine whether the identification of the photovoltaic device carried in the received first response signal is consistent with that of the photovoltaic device carried in the second signal instruction. If yes, the value of the signal feature of the received first response signal may be compared with the corresponding signal threshold; if no, it may be considered that the first response signal is not sent by the first photovoltaic device specified by the second signal instruction, and no comparison may be made. For example, the other photovoltaic devices may determine whether the sequence number of the photovoltaic device carried in the received first response signal is the same as that of the photovoltaic device carried in the second signal instruction.

At the present step, the photovoltaic device may compare the signal feature of the received first response signal with the corresponding signal threshold, and determine whether itself is the second photovoltaic device according to the comparing result. The second photovoltaic device may determine the grouping information thereof according to the signal feature of the received response signal and the corresponding signal threshold, and the grouping information may include the identification of a corresponding first photovoltaic device.

Step 408 may include that the photovoltaic device that successfully responds to the search instruction for the first photovoltaic device sending a second response signal.

At the present step, when the management module successfully receives the second response signal, it may indicate that the photovoltaic device that successfully responds to the search instruction for the first photovoltaic device is successfully registered as a first photovoltaic device, and the method may return to the step 401.

At the present step, the photovoltaic device that successfully responds to the search instruction for the first photovoltaic device may be the first photovoltaic device determined at the step 405.

Based on step 401 to step 408, the first photovoltaic device and the second photovoltaic device of the plurality of photovoltaic devices in the at least one photovoltaic string are determined and the search of the first photovoltaic device may be achieved.

For each of the at least one photovoltaic string, steps in the FIG. 5 may be performed to implement the search for the second photovoltaic device.

Step 409 may include that the management module sending a search instruction for the second photovoltaic device.

At the present step, the management module may send the search instruction for the second photovoltaic device to the plurality of photovoltaic devices in the broadcast manner, all unregistered second photovoltaic devices competitively participate in responding to the search instruction for the second photovoltaic device.

In an embodiment, the search instruction for the second photovoltaic device may include identification of a first photovoltaic device, the unregistered second photovoltaic devices located in the same photovoltaic string as the first photovoltaic device may competitively participate in responding to the search instruction for the second photovoltaic device, i.e., the second photovoltaic device whose grouping information is consistent with the identification of the first photovoltaic device carried in the search instruction for the second photovoltaic device may competitively participate in responding to the search instruction for the second photovoltaic device. In this situation, the search range for the second photovoltaic device may be narrowed to one photovoltaic string, greatly narrowing the search range, and improving the search efficiency for the second photovoltaic device.

In another embodiment, before the management module sends the search instruction for the second photovoltaic device, the management module may send the notification instruction in the broadcast manner. The notification instruction may include the identification of a first photovoltaic device, the notification instruction is configured to notify second photovoltaic devices that the second photovoltaic device located in the same photovoltaic string as the first photovoltaic device specified in the notification instruction responds to the search instruction for the second photovoltaic device that is sent later, and the second photovoltaic device whose grouping information is consistent with the identification of the first photovoltaic device carried in the notification instruction may competitively participate in responding. In this situation, the search instruction for the second photovoltaic device does not need to carry the identification of the first photovoltaic device.

Step 410 may include that a second photovoltaic device sending a third response signal that includes identification of the second photovoltaic device.

Step 411 may include that the management module determining whether to receive the third response signal, if yes, performing step 412; if no, performing step 414.

Step 412 may include that the management module sending a registering instruction for the second photovoltaic device to the second photovoltaic device.

At the present step, the corresponding second photovoltaic device may be notified by the registering instruction for the second photovoltaic device that itself has been registered. Subsequently, the registered second photovoltaic device does not respond to the search instruction for the second photovoltaic device any more.

Step 413 may include that the second photovoltaic device sending a fourth response signal.

In an embodiment, the step 413 may be omitted, and the registering instruction for the second photovoltaic device may be repeatedly sent for certain times.

Step 414 may include that the management module determining whether the third response signal is not received for certain times, if yes, performing the step 409; if no, ending the search process. The search and registration for all photovoltaic devices is completed.

The times that the management module does not receive the third response signal may be set according to the practical situation.

In other embodiments, the step 401 to step 403 may be omitted. In this case, the to-be-grouped photovoltaic devices may competitively respond to the search instruction for the first photovoltaic device at step 404.

In the present embodiment, after the search and registration for the first photovoltaic device in all of the at least one photovoltaic string are completed, the search and registration for the second photovoltaic device may be performed.

In other embodiments, after the search and registration for the first photovoltaic device in one photovoltaic string are completed, the search for the second photovoltaic device and registration for the second photovoltaic device in this photovoltaic string may be performed.

It should be noted that, although each of a plurality of steps in the above flowcharts is sequentially shown as indicated by arrows, the plurality of steps may not be necessary to be sequentially executed as an order indicated by the arrows. Unless otherwise specified in the present disclosure, there is no strict order limit for execution of these steps, and these steps may be executed in other orders. Moreover, at least some of the steps in the above flowcharts may include multiple steps or stages, which are not necessarily executed at the same time, but may be executed at different time. An execution order of these steps or stages may not be necessarily sequential, but be in turn or alternatively executed with other steps, or at least a part of steps or stages of the other steps.

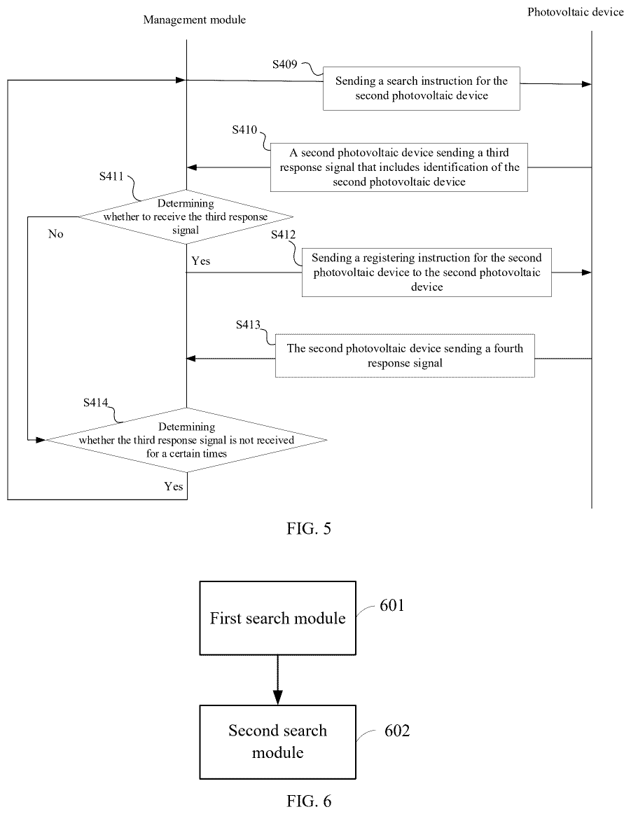

In an embodiment, referring to FIG. 6, the present disclosure provides a management module for the photovoltaic devices, which is applied to the photovoltaic system referring to FIG. 1 or FIG. 2. The management module includes a first search module 601 and a second search module 602.

The first search module 601 is configured for sending a search instruction for a first photovoltaic device to the plurality of photovoltaic devices, and determining a first photovoltaic device in each of the at least one photovoltaic string based on a first response signal sent by a photovoltaic device that successfully responds to the search instruction for the first photovoltaic device, and implementing search for the first photovoltaic device in each of the at least one photovoltaic string. The first photovoltaic device is configured to determine a second photovoltaic device that is located in a same photovoltaic string as the first photovoltaic device.

The second search module 602 is configured for sending a search instruction for a second photovoltaic device to the plurality of photovoltaic devices based on a first photovoltaic device, to implement search for the second photovoltaic device in each of the at least one photovoltaic string. The second photovoltaic device located in the same photovoltaic string as the first photovoltaic device competitively participates in responding to the search instruction for the second photovoltaic device.

The specific limitation of the management module may refer to the limitation for the photovoltaic device search method, which is not described herein in detail. Each module of the management module may be overall or partly realized by software, hardware and combination of the software and the hardware. The above modules may be embedded in hardware form in or independent of the processor in a computer device, or stored in a software form in a memory of the computer device, facilitating the processor calling and executing operations corresponding to the above modules.

In an embodiment, the present disclosure provides a photovoltaic system, including a plurality of photovoltaic strings and the management module in the above embodiments. Each of the plurality of photovoltaic strings includes the plurality of photovoltaic devices in the above embodiments and a plurality of photovoltaic modules connected to the plurality of photovoltaic devices respectively. The management module communicates with the plurality of photovoltaic devices.

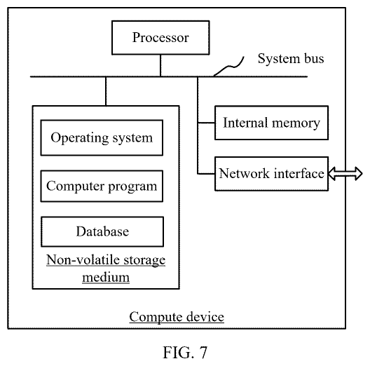

In an embodiment, a computer device is provided. The computer device may be a server, and an inner structure thereof may refer to FIG. 7. The computer device includes a processor, a memory, and a network interface connected through a system bus. The processor of the computer device is configured to provide computing and control capabilities. The memory of the computer device includes a non-volatile storage medium and an internal memory. The non-volatile storage medium stores an operating system, a computer program, and a database. This internal memory provides an environment for the operation of the operating system and the computer program in the non-volatile storage medium. The database of the computer device is configured to store action detection data. The network interface of the computer device is configured to communicate with an external terminal via a network connection. The computer program is executed by the processor to implement any of the steps in the embodiments of the photovoltaic device search method described above.

One skilled in the art may understand that the structure referring to FIG. 7, which is only a block diagram of a part of the structure related to the present disclosure, does not constitute a limitation on the computer device to which the present disclosure is applied. Specific computer device may include more or fewer components than that shown in the FIG. 7, or combine certain components, or have different component arrangements.

In an embodiment, a computer device is provided, including a memory and a processor. The memory stores a computer program, and the processor executes the computer program to implement any of the steps in the photovoltaic device search method embodiments described above.

In an embodiment, a computer-readable storage medium is provided, on which a computer program is stored. When the computer program is executed by a processor, it implements any of the steps in the photovoltaic device search method embodiments described above.

One skilled in the art may understand that implementing all or part of the processes in the above embodiments may be accomplished by instructing relevant hardware through the computer program. The computer program may be stored in a non-volatile computer-readable storage medium, and when the computer program is executed, it can include the processes of the embodiments of the above methods. Any reference to the memory, the storage medium, the database or other medium used in the embodiments provided in this disclosure may include at least one of a non-volatile memory or a volatile memory. The non-volatile memory may include a Read Only Memory (ROM), a magnetic tape, a floppy disk, a flash memory, or an optical storage. The volatile memory may include a Random Access Memory (RAM) or an external cache memory. As an illustration and not a limitation, the RAM may take various forms, such as a Static Random Access Memory (SRAM) or a Dynamic Random Access Memory (DRAM), etc.

The various technical features of the above embodiments may be combined arbitrarily, and all possible combinations of the various technical features of the above-described embodiments have not been described for the sake of conciseness of description. However, as long as there is no contradiction in the combinations of these technical features, they should be considered to be within the scope of the present description.

The above-described embodiments express only several embodiments of the present disclosure, which are described in a more specific and detailed manner, but are not to be construed as a limitation on the scope of the present disclosure. For one skilled in the art, several deformations and improvements can be made without departing from the conception of the present disclosure, all of which fall within the scope of protection of the present disclosure. Therefore, the scope of protection of the present disclosure shall be subject to the attached claims.

What is claimed is:

1. A photovoltaic device search method, applied to a management module in a photovoltaic system, and the photovoltaic system further comprising at least one photovoltaic string, each of which comprises a plurality of photovoltaic devices connected in series and a plurality of photovoltaic modules connected to the plurality of photovoltaic devices respectively, wherein the method comprises:
sending a search instruction for a first photovoltaic device to the plurality of photovoltaic devices;
determining a first photovoltaic device and achieving search for the first photovoltaic device in each of the at least one photovoltaic string based on a first response signal sent by a photovoltaic device that successfully responds to the search instruction for the first photovoltaic device, wherein the first photovoltaic device is configured to determine a second photovoltaic device that is located in a same photovoltaic string as the first photovoltaic device; and
sending a search instruction for a second photovoltaic device to the plurality of photovoltaic devices based on the first photovoltaic device, so as to implement search for the second photovoltaic device in each of the at least one photovoltaic string, wherein the second photovoltaic device located in the same photovoltaic string as the first photovoltaic device competitively participates in responding to the search instruction for the second photovoltaic device.

2. The method of claim 1, wherein the first response signal comprises identification of the photovoltaic device that successfully responds to the search instruction for the first photovoltaic device.

3. The method of claim 1, wherein the search instruction for the second photovoltaic device comprises identification of the first photovoltaic device.

4. The method of claim 1, wherein before sending the search instruction for the second photovoltaic device, the method further comprises:
broadcasting a notification instruction to the plurality of photovoltaic devices, wherein the notification instruction comprises identification of the first photovoltaic device, and the notification instruction is configured to notify the second photovoltaic device located in the same photovoltaic string as the first photovoltaic device to competitively participate in responding to the search instruction for the second photovoltaic device.

5. The method of claim 1, wherein photovoltaic devices other than the first photovoltaic device and the second photovoltaic device competitively participate in responding to the search instruction for the first photovoltaic device.

6. The method of claim 1, wherein after sending the search instruction for the first photovoltaic device to the plurality of photovoltaic devices, the method further comprises:
sending a second signal instruction to the plurality of photovoltaic devices, wherein the second signal instruction comprises a signal threshold configured to determine a second photovoltaic device that is located in the same photovoltaic string as a corresponding first photovoltaic device and grouping information of the second photovoltaic device, the grouping information is determined by the second photovoltaic device according to a signal feature of a response signal received by the second photovoltaic device and a corresponding signal threshold, and the grouping information comprises identification of the corresponding first photovoltaic device.

7. The method of claim 6, wherein the second signal instruction is configured to instruct each of the plurality of photovoltaic devices to determine whether a corresponding photovoltaic device is the second photovoltaic device based on a signal feature of a received first response signal and a corresponding signal threshold.

8. The method of claim 6, wherein the second signal instruction further comprises identification of the corresponding first photovoltaic device configured to register the corresponding first photovoltaic device.

9. The method of claim 6, further comprising:
receiving a third response signal sent by a second photovoltaic device that successfully responds to the search instruction for the second photovoltaic device, wherein the third response signal comprises identification of the second photovoltaic device.

10. The method of claim 9, wherein after receiving the third response signal sent by the second photovoltaic device that successfully responds to the search instruction for the second photovoltaic device, the method further comprises:
sending a registering instruction for a second photovoltaic device to the second photovoltaic device, wherein the registering instruction for the second photovoltaic device comprises the identification of the second photovoltaic device in the third response signal, and the registering instruction for the second photovoltaic device is configured to register a corresponding second photovoltaic device.

11. The method of claim 10, wherein both the second signal instruction and the registering instruction for the second photovoltaic device further comprise a logical address assigned to a corresponding photovoltaic device to implement networking of photovoltaic devices.

12. A management module, applied to a photovoltaic system, and the photovoltaic system further comprising at least one photovoltaic string, each of which comprises a plurality of photovoltaic devices connected in series and a plurality of photovoltaic modules connected to the plurality of photovoltaic devices respectively, wherein the management module comprises a first search module and a second search module;
the first search module is configured for sending a search instruction for a first photovoltaic device to the plurality of photovoltaic devices, determining a first photovoltaic device and achieving search for the first photovoltaic device in each of the at least one photovoltaic string based on a first response signal sent by a photovoltaic device that successfully responds to the search instruction for the first photovoltaic device, wherein the first photovoltaic device is configured to determine a second photovoltaic device that is located in a same photovoltaic string as the first photovoltaic device; and
the second search module is configured for sending a search instruction for a second photovoltaic device to the plurality of photovoltaic devices based on the first photovoltaic device, so as to implement search for the second photovoltaic device in each of the at least one photovoltaic string, wherein the second photovoltaic device located in the same photovoltaic string as the first photovoltaic device competitively participates in responding to the search instruction for the second photovoltaic device.

13. A photovoltaic system, comprising the at least one photovoltaic string and the management module of claim 12, wherein each of the at least one photovoltaic string comprises a plurality of photovoltaic devices connected in series and a plurality of photovoltaic modules connected to the plurality of photovoltaic devices respectively.

14. A computer-readable storage medium, storing a computer program, wherein the computer program is executed by a processor to perform the method of claim 1.

15. The computer-readable storage medium of claim 14, wherein the first response signal comprises identification of the photovoltaic device that successfully responds to the search instruction for the first photovoltaic device.

16. The computer-readable storage medium of claim 14, wherein the search instruction for the second photovoltaic device comprises identification of the first photovoltaic device.

17. The computer-readable storage medium of claim 14, wherein before sending the search instruction for the second photovoltaic device, the method further comprises:
broadcasting a notification instruction to the plurality of photovoltaic devices, wherein the notification instruction comprises identification of the first photovoltaic device, and the notification instruction is configured to notify the second photovoltaic device located in the same photovoltaic string as the first photovoltaic device to competitively participate in responding to the search instruction for the second photovoltaic device.

18. The computer-readable storage medium of claim 14, wherein photovoltaic devices other than the first photovoltaic device and the second photovoltaic device competitively participate in responding to the search instruction for the first photovoltaic device.

19. The computer-readable storage medium of claim 14, wherein after sending the search instruction for the first photovoltaic device to the plurality of photovoltaic devices, the method further comprises:
sending a second signal instruction to the plurality of photovoltaic devices, wherein the second signal instruction comprises a signal threshold configured to determine a second photovoltaic device that is located in the same photovoltaic string as a corresponding first photovoltaic device and grouping information of the second photovoltaic device, the grouping information is determined by the second photovoltaic device according to a signal feature of a response signal received by the second photovoltaic device and a corresponding signal threshold, and the grouping information comprises identification of the corresponding first photovoltaic device.

20. The computer-readable storage medium of claim 19, wherein the second signal instruction is configured to instruct each of the plurality of photovoltaic devices to determine whether a corresponding photovoltaic device is the second photovoltaic device based on a signal feature of a received first response signal and a corresponding signal threshold.
